(19) United States
(12) Patent Application Publication
(10) Pub. No.: US 2011/0086674 A1
(43) Pub. Date: Apr. 14, 2011

(54) ELECTRONIC DEVICE INCLUDING TOUCH-SENSITIVE DISPLAY AND METHOD OF CONTROLLING SAME

(75) Inventors: Douglas Clayton RIDER, Ottawa (CA); Colin Stephen HO, Ottawa (CA); Jeffrey Brent KENNEY, Nepean (CA)

(73) Assignee: RESEARCH IN MOTION LIMITED, Waterloo (CA)

(21) Appl. No.: 12/872,942

(22) Filed: Aug. 31, 2010

Related U.S. Application Data
(60) Provisional application No. 61/251,545, filed on Oct. 14, 2009.

(51) Int. Cl. H04B 1/38; G06F 3/041

(52) U.S. Cl. 455/566; 345/173

(57) ABSTRACT

A method includes associating regions of a touch-sensitive display with information, detecting a touch on the touch-sensitive display, determining an area associated with the touch, and associating probability values with at least some of the information based on an area associated with the touch and the regions associated with the information.

### CROSS-REFERENCE TO RELATED APPLICATIONS

This application claims the benefit of U.S. Provisional Patent Application 61/251,545, filed Oct. 14, 2009, the entire content of which is incorporated herein by reference.

### FIELD OF TECHNOLOGY

The present disclosure relates to electronic devices, including but not limited to portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones, wireless PDAs, and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed.

Improvements in devices with touch-sensitive displays are desirable.

### BRIEF DESCRIPTION OF THE DRAWINGS

FIG. 1 is a block diagram of a portable electronic device in accordance with the present disclosure.

FIG. 2 is a flowchart illustrating a method of controlling an electronic device in accordance with the present disclosure.

FIG. 3 illustrates examples of control of a portable electronic device when a touch received at a touch-sensitive display in accordance with the present disclosure.

FIG. 4 is a flowchart illustrating a method of controlling an electronic device in accordance with the present disclosure.

FIG. 5 illustrates examples of control of a portable electronic device when a touch received at a touch-sensitive display in accordance with the present disclosure.

### DETAILED DESCRIPTION

The following describes an electronic device and method of controlling the electronic device. The method may include associating regions of a touch-sensitive display with information, detecting a touch on the touch-sensitive display, determining an area associated with the touch, and associating probability values with at least some of the information based on an area associated with the touch and the regions associated with the information. Alternatively, the method may include associating regions of a touch-sensitive display with information, detecting a touch on the touch-sensitive display, determining distances from the touch to at least some of the regions, and associating probability values with at least some of the information based on the distances.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable electronic device in the embodiments described herein. Examples of portable electronic devices include mobile, or handheld, wireless communication devices such as pagers, cellular phones, cellular smart-phones, wireless organizers, personal digital assistants, wirelessly enabled notebook computers, and so forth. The portable electronic device may also be a portable electronic device without wireless communication capabilities, such as a handheld electronic game device, digital photograph album, digital camera, or other device.

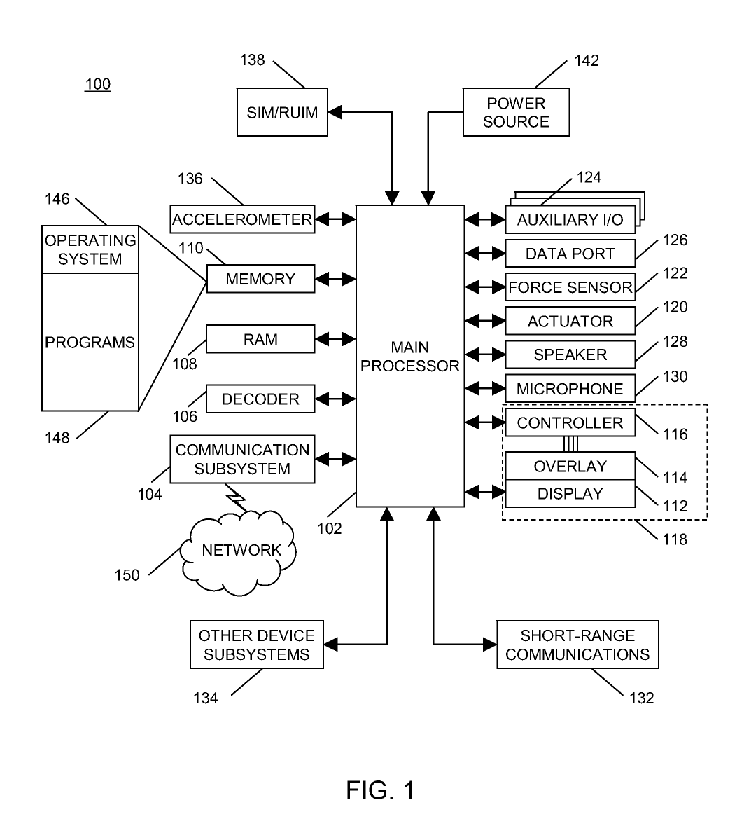

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably coupled to an electronic controller 116 that together comprise a touch-sensitive display 118, one or more actuators 120, one or more force sensors 122, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display may include a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact, or a point of contact including width information in both x and y axes, or a single point of contact, such as a point at or near a center of the area of contact. The location of a detected touch may include x and y components, e.g., horizontal and vertical components, respectively, with respect to one's view of the touch-sensitive display 118. For example, the x location component may be determined by a signal generated from one touch sensor, and the y location component may be determined by a signal generated from another touch sensor. A signal is provided to the controller 116 in response to detection of a touch. A touch may be detected from any suitable object, such as a finger, thumb, appendage, or other items, for example, a stylus, pen, or other pointer, depending on the nature of the touch-sensitive display 118. The controller 116 and/or the processor 102 may detect a touch by any suitable contact object on the touch-sensitive display 118. Multiple simultaneous touches may be detected.

The actuator(s) 120 may be depressed by applying sufficient force to the touch-sensitive display 118 to overcome the actuation force of the actuator 120. The actuator 120 may be actuated by pressing anywhere on the touch-sensitive display 118. Input may be provided to the processor 102 when the actuator 120 is actuated. Actuation of the actuator 120 may result in provision of tactile feedback.

A mechanical dome switch actuator may be utilized. In this example, tactile feedback is provided when the dome collapses due to imparted force and when the dome returns to the rest position after release of the switch.

Alternatively, the actuator 120 may comprise one or more piezoelectric (piezo) devices that provide tactile feedback for the touch-sensitive display 118. Contraction of the piezo actuator(s) applies a spring-like force, for example, opposing a force externally applied to the touch-sensitive display 118.

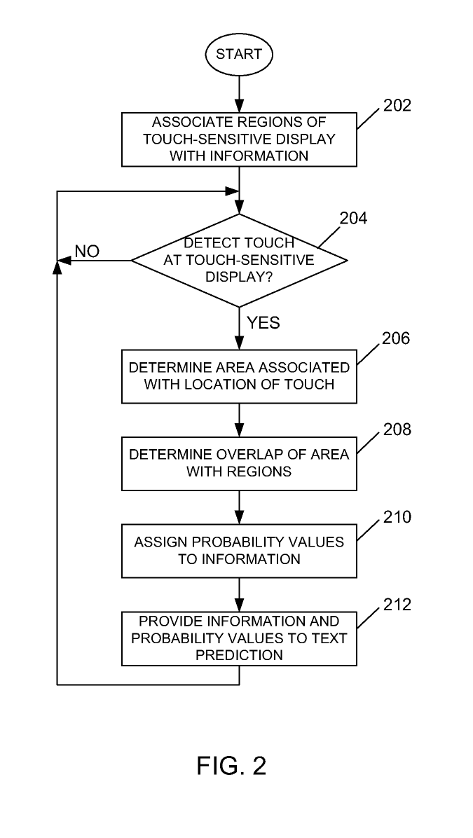

A flowchart illustrating a method of controlling an electronic device is shown in FIG. 2. The method may be carried out by software executed by, for example, the processor 102. Coding of software for carrying out such a method is within the scope of a person of ordinary skill in the art given the present description.

Regions of the touch-sensitive display 118 are associated 202 with information, such as characters or functions or characters and functions that are displayed via virtual keys of a keyboard. The characters and functions are associated with the regions for selection of a character or function in an application. The application may be any suitable application. Suitable applications include an electronic mail application, a text application, a calendar application, an address book application, a task application, a memo application, and so forth.

When a touch is detected 204, the location of the touch on the touch-sensitive display 118 is determined. An area is associated 206 with the location of the touch. The area may be any suitable size and any suitable shape, such as a square area, rectangular area, circular area and so forth. The size and shape of the area may be adjusted to optimize performance. The area may surround the location of the touch, such that the location of the touch is centered on the area, or may be offset from the center. Alternatively, the area may be an area of contact of the touch on a touch-sensitive display 118 that is configured to determine an area of contact of the touch. Alternatively, the area may be determined based on the touch location and width in the x direction and length in the y direction.

The portion of the area that overlaps with each region is determined 208. A probability value is assigned 210 to information for each region based on the area of overlap. For example, the probability that is assigned may be a value determined by dividing the area of overlap with a region by the total area associated with the touch such that the probability value that is assigned to the information is less than one. For information with associated regions that do not overlap with the area associated with the touch, the probability value is zero. Optionally, a very low probability value may be assigned.

The probability values assigned to characters may be provided 212 to predictive text software, for example, along with the characters associated with each of the regions. The probability values may be taken into account by the predictive text software to facilitate determination of the intended selection.

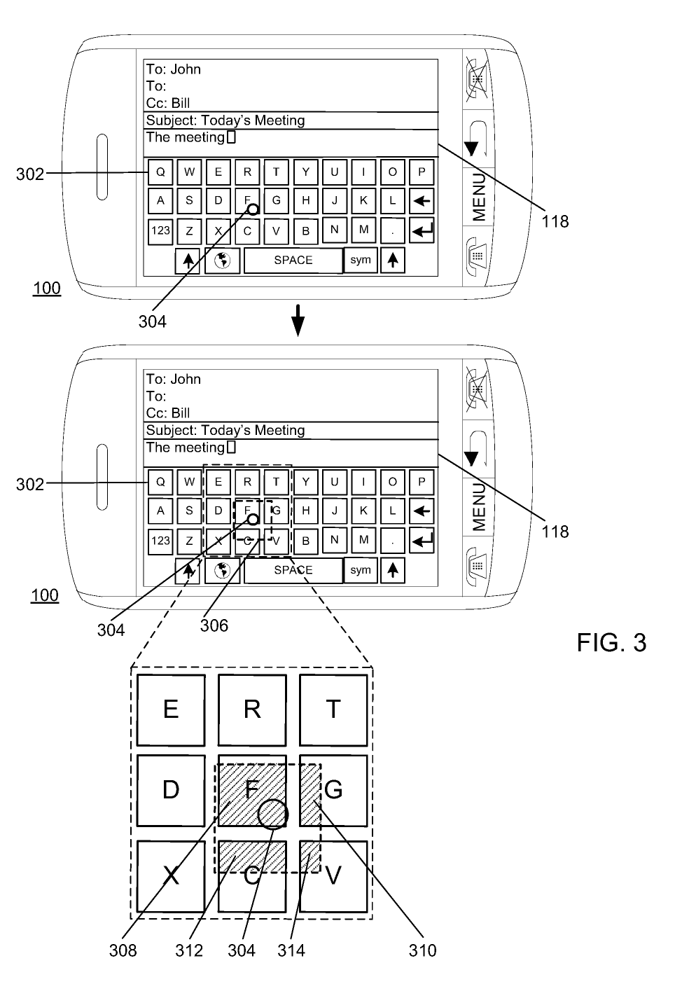

An example of control of an electronic device when a touch is received is illustrated in FIG. 3. The regions of the touch-sensitive display 118 are associated with characters displayed in virtual keys of a keyboard 302 in an electronic mail application in the example of FIG. 3. The keyboard 302 shown is a QWERTY keyboard rendered on the touch-sensitive display 118. The present disclosure may be applied to other keyboard layouts. Each character and function shown in FIG. 3 is associated with a respective region. The region associated with each letter and function may correspond to the displayed key such that the regions are separated by a space. Optionally, the region associated with each character and function may differ from the displayed area for the key. For example, the region may be larger than the displayed area for the key such that the space between the regions is smaller than the space displayed between the keys or no space may exist between the regions. The region associated with each character and function corresponds with the displayed key in the example of FIG. 3, such that the boundaries of the region correspond with the displayed boundaries of the key.

A touch, depicted by the circle 304 in the upper illustration of FIG. 3, is detected and the location of the touch on the touch-sensitive display 118 is determined. The area 306 is associated with the location of the touch. In the example of FIG. 3, the area 306 is a square area that is centered on the location of the touch, as shown in the lower illustration of FIG. 3.

The area 306 overlaps with four keys displayed on the keyboard 302 and overlaps with the associated regions of the four characters. The four characters include the letters “F”, “G”, “C” and “V”. The portion of the area that overlaps with the region associated with the key for the letter “F” 308 is cross-hatched for the purpose of illustration. The portion of the area that overlaps with the regions associated with the keys for the letter “G” 310, the letter “C” 312, and the letter “V” 314 are also cross-hatched for the purpose of illustration. The area of overlap is determined for each of the regions.

A probability value is assigned to each of the letters “F”, “G”, “C”, and “V” utilizing the area of overlap for each of the associated regions. The probability value is determined by dividing the area of overlap, for each region, by the total area of overlap of all the regions. In this example, the letter “F” is assigned the highest probability value because the area 306 overlaps more of the region associated with the letter “F” than any other region. Of the four letters “F”, “G”, “C” and “V”, the letter “V” is assigned the lowest probability value because the area 306 overlaps less of the region associated with the letter “V” than for the letters “F”, “G”, and “C”.

The probability values assigned to each of the regions are provided to predictive text software.

Optionally, the probability values may be assigned to characters and not to functions such as the enter function, shift function, symbol function, number lock function, backspace function, and space keys. A location of touch that is within one of the regions associated with a function may result in selection of the function and a probability value may not be assigned to the function. In this embodiment, probability values are determined for characters, such as letters, when the location of touch is not within one of the regions associated with a function, and probability values are not assigned to functions. Optionally, probability values may be assigned to functions including functions that affect which characters or symbols are associated with the regions.

The regions associated with the information may change based on frequency of use or based on, for example, words in a device dictionary or spell-checker. For example, when letters are entered in a string, terms that begin with that string may be identified and the regions associated with the next letter for each of the terms may be increased in size while others remain static or are reduced in size. Small changes in region sizes may be made to reduce difficulty of selecting letters, for example for terms that are not included in the device spell-checker.

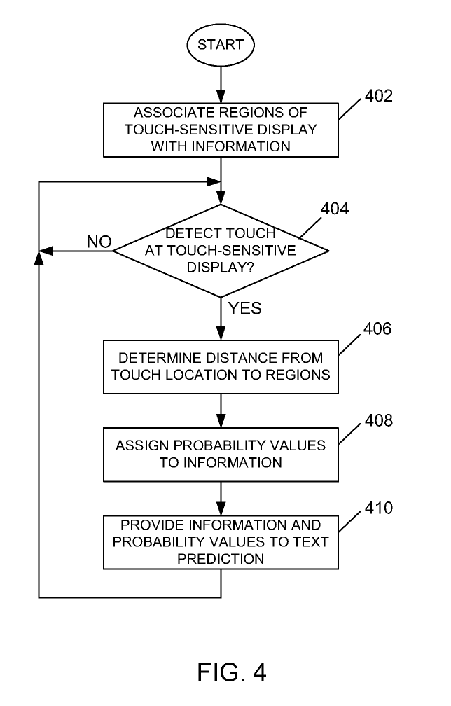

A flowchart illustrating another method of controlling an electronic device is shown in FIG. 4. The method may be carried out by software executed by, for example, the processor 102. Coding of software for carrying out such a method is within the scope of a person of ordinary skill in the art given the present description.

Regions of the touch-sensitive display 118 are associated 402 with information, such as characters that are displayed in the display area of the virtual keys of a keyboard. The regions are advantageously smaller than the displayed area for each key. The regions may be any suitable size and any suitable shape, such as a square area, rectangular area, circular area, oval area and so forth. The size and shape of the regions may be adjusted to optimize performance. When a touch is detected 404, the location of the touch on the touch-sensitive display 118 is determined. A distance from the location of the touch to the region is determined 406 for at least some of the regions. The distance determined is the shortest distance from the location of the touch to the region. A probability value is assigned 408 to the information based on the distance. For example, the probability assigned to the information associated with the region may be 1 when the touch location is within the region. The probability assigned to other information may be zero. When the touch location is not within the region, the probability may be determined by dividing the distance, for example for each of 4 closest regions, by the sum of the distances to each of the four regions. The number determined from the division is subtracted from 1 to provide the probability for the information. The probability values assigned to the information may be provided 410 to predictive text software, for example, along with the information associated with each of the regions. The probability values may be taken into account by the predictive text software to facilitate determination of the intended selection.

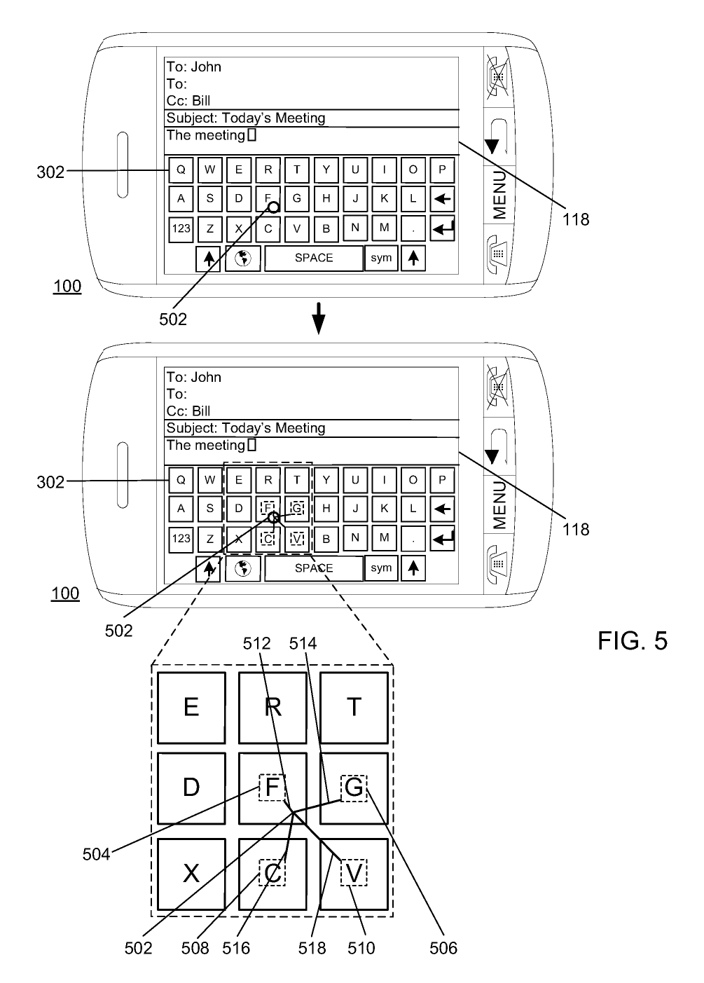

An example of control of an electronic device when a touch is received is illustrated in FIG. 5. The regions of the touch-sensitive display 118 are associated with characters arranged in virtual keys of a keyboard 302 in an electronic mail application in the example of FIG. 5. The keyboard 302 shown is a QWERTY keyboard rendered on the touch-sensitive display 118. The present disclosure may be applied to other keyboard layouts. Each character and function shown in FIG. 5 is associated with a respective region. The region associated with each character and function may be smaller than the displayed key.

A touch, depicted by the circle 502 in the upper illustration of FIG. 5, is detected and the location of the touch on the touch-sensitive display 118 is determined. The distance from the location of the touch to the region is determined for each of the four closest regions. The four closest regions 504, 506, 508, 510 are associated with characters. The characters include the letters “F”, “G”, “C” and “V”. The shortest distance from the location of touch to each of the four regions 504, 506, 508, 510 is determined. The distances 512, 514, 516, 518 are illustrated as lines in FIG. 5. The sum of the distances 512, 514, 516, 518 is also determined. Probability values are determined by subtracting from 1, the product of each distance by the sum of the distances. For example, the probability value for the letter “F” is determined as:

1−(distance 512/Sum of distances 512, 514, 516, 518).

The probability value for the letter “G” is determined as:

1−(distance 514/Sum of distances 512, 514, 516, 518).

The probability value for the letter “C” is determined as:

1−(distance 516/Sum of distances 512, 514, 516, 518).

The probability value for the letter “V” is determined as:

1−(distance 518/Sum of distances 512, 514, 516, 518).

The probability values are assigned to each of the letters “F”, “G”, “C” and “V” and are provided to predictive text software along with the letters.

Optionally, probability values may be assigned to functions including functions that affect which characters or symbols are associated with the regions.

The regions associated with the information may change based on frequency of use or based on, for example, words in a device dictionary or spell-checker. For example, when letters are entered in a string, terms that begin with that string may be identified and the regions associated with the next letter for each of the terms may be increased in size while others remain static or are reduced in size. Small changes in region sizes may be made to reduce difficulty of selecting letters, for example for terms that are not included in the device spell-checker.

The probability values may also be determined based on other factors. The probability values described above with reference to FIG. 2 and FIG. 4 may be adjusted prior to assigning the probability values. For example, the probability values may be adjusted based on time between touches. Optionally, a selection may be made by depressing the touch-sensitive display 118 to actuate the actuator 120. An offset may be utilized to favor selection of information associated with the closest region when touch contact is made with the touch-sensitive display 118 for some threshold period of time prior to depression of the touch-sensitive display 118. For example, when touch contact with the touch-sensitive display 118 exceeds 0.5 seconds prior to selection of the information, the probability value assigned to the information with the closest associated region may be increased by, for example, 10% of the total probability. The probability values assigned to other information may be decreased.

The present disclosure may also apply to touch-sensitive keyboards or touch-sensitive pads in which regions of the touch-sensitive keyboards or touch-sensitive pads are associated with information.

A method includes associating regions of a touch-sensitive display with information, detecting a touch on the touch-sensitive display, determining an area associated with the touch, and associating probability values with at least some of the information based on the area associated with the touch and the regions associated with the information.

A computer-readable medium has computer-readable code executable by at least one processor of a portable electronic device to perform the above method.

An electronic device includes a touch-sensitive display to receive a touch and at least one processor coupled to the touch-sensitive display to render information on the touch-sensitive display, associate regions of a touch-sensitive display with the information, detecting the touch, and associate probability values with at least some of the information based on the area associated with the touch and the regions associated with the information.

A method includes associating regions of a touch-sensitive display with information, detecting a touch on the touch-sensitive display, determining distances from the touch to at least some of the regions, and associating probability values with at least some of the information based on the distances.

A computer-readable medium has computer readable code executable by at least one processor of a portable electronic device to perform the above method.

A portable electronic device includes a touch-sensitive display to receive a touch and at least one processor coupled to the touch-sensitive display to render information on the touch-sensitive display, detect the touch on the touch-sensitive display, determine distances from the touch to at least some of the regions, and associate probability values with at least some of the information based on the distances

Assigning probability values to information, such as characters, and the use of the probability values, for example in text prediction, facilitates the determination of a selection. Entry errors that occur during use of a touch-sensitive display may be reduced, reducing device use time during entry and decreasing power consumption.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method comprising:
associating regions of a touch-sensitive display with information;
detecting a touch on the touch-sensitive display;
determining an area associated with the touch;
associating probability values with at least some of the information based on the area associated with the touch and the regions associated with the information.

2. The method according to claim 1, wherein the information comprises characters.

3. The method according to claim 1, wherein the information comprises characters and functions.

4. The method according to claim 3, wherein the functions comprise functions that affect which information is associated with the regions.

5. The method according to claim 1, wherein determining an area associated with the touch comprises determining an area of contact of the touch on the touch-sensitive display.

6. The method according to claim 1, wherein detecting a touch comprises determining a point location of the touch.

7. The method according to claim 6, wherein the area surrounds the point location.

8. The method according to claim 1, comprising determining values related to the overlap of the area with the respective regions associated with the information.

9. The method according to claim 8, wherein the probability values are based on the values related to the overlap.

10. The method according to claim 1, comprising providing the probability values, for the information, to predictive text software.

11. A computer-readable medium having computer readable code executable by at least one processor of a portable electronic device to perform the method of claim 1.

12. An electronic device comprising:
a touch-sensitive display to receive a touch;
at least one processor coupled to the touch-sensitive display and configured to render information on the touch-sensitive display, associate regions of a touch-sensitive display with the information, detecting the touch, and associate probability values with at least some of the information based on the area associated with the touch and the regions associated with the information.

13. The electronic device according to claim 12, wherein the information comprises characters.

14. The electronic device according to claim 12, wherein the information comprises characters and functions.

15. The electronic device according to claim 14, wherein the functions comprise functions that affect which information is associated with the regions.

16. The electronic device according to claim 12, wherein the area associated with the touch comprises an area of contact of the touch on the touch-sensitive display.

17. The electronic device according to claim 12, wherein the touch-sensitive display is configured to determine a point location of the touch.

18. The electronic device according to claim 17, wherein the area surrounds the point location.

19. The electronic device according to claim 12, wherein the probability values are based on the values related to overlap of the area with respective regions associated with the information.
